(19) United States
(12) Patent Application Publication
(10) Pub. No.: US 2008/0252815 A1
(43) Pub. Date: Oct. 16, 2008

(54) Polarization structure and liquid crystal display device having the same

(75) Inventors: Po-Hsien Wang, Taichung City (TW); Wei-Lung Lin, Taichung County (TW); Ping-Wen Huang, Taichung City (TW); Hong-En Yang, Taichung City (TW); Wen-Jung Tsai, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/785,018

(22) Filed: Apr. 13, 2007

(51) Int. Cl. G02F 1/1335; F21V 9/14; G02B 5/30

(52) U.S. Cl. 349/64; 359/485; 362/355

(57) ABSTRACT

A polarization structure and a liquid crystal display device having the same are provided. The polarization structure includes a polarizing film, a phase compensation film layer, and a diffusing adhesive layer. The phase compensation film layer is disposed on the polarizing film, and the diffusing adhesive layer is disposed on one side of the phase compensation film layer opposite to the polarizing film. The diffusing adhesive layer has an adhesive material and a plurality of diffusing particles added into the adhesive material.

### BACKGROUND OF THE INVENTION

1. Field of Invention

The present invention relates to a liquid crystal display (LCD) device, and more particularly, to a polarization structure and a liquid display device having the same.

2. Related Art

Generally speaking, an LCD device mainly includes an LCD panel, a polarization structure and a backlight module. That is, an upper polarization structure is disposed on an upper side surface of the LCD panel, and a lower polarization structure is disposed between the lower side of the LCD panel and the backlight module.

When a light interference regularly occurs between the backlight module and the liquid crystal panel, visible fringe lines appear on a display frame, which is referred to as the “Moire phenomenon”. Particularly, in the display mode of a high focus level, or in a light-gray background, the moire phenomenon can be easily observed. Therefore, it is necessary to avoid the moire phenomenon, so as to provide a preferred image quality.

Conventionally, a diffusion sheet is added on the backlight module or a brightness enhancement film is adjusted to uniformly disperse the light source, thereby reducing the moire phenomenon.

Referring to FIG. 1, a conventional backlight module 10 is disposed below an LCD panel 20, and includes a light source generator 11, a reflecting plate 12, a light guide plate 13, a diffusion sheet 14, and at least one prism sheet 15. The light source generator 11 provides a light source to the LCD panel 20. The reflecting plate 12 reflects the light generated by the light source generator 11 upwards, so as to increase the usage rate of the light and further to provide a preferred brightness output. The light guide plate 13 disperses the light generated by the light source generator 11 to the diffusion sheet 14, so that the diffusion sheet 14 further disperses the light, thereby providing more uniformly dispersed light to the LCD panel 20. Furthermore, one or more prism sheets 15 are usually disposed above the diffusion sheet 14 to further condense light and enhance brilliance. Here, the number of the disposed prism sheets can change in accordance with the requirement.

However, the diffusion sheet may cause an increase in cost, and also lead to an increased thickness of the entire film, which can not meet the requirement for thinnerization of the current market.

Referring to FIG. 2, another conventional backlight module 10 adopts two prism sheets 15, 16. Here, the first prism sheet 15 and the second prism sheet 16 are arranged in different directions intersected at a predetermined angle, so as to prevent the moire phenomenon. However, different display panels and backlight modules are required to adjust the intersection angle of the two prism sheets, thus achieving the effect of preventing the moire phenomenon. Thus, the material specification cannot be unified and it is difficult to acquire a preferred intersection angle.

Moreover, a special design of prism has been proposed in Taiwan Patent Publication NO. 200502652, which is used to control the optical coupling of the contact surface between two prisms in the backlight module, so as to prevent the moire phenomenon and further to provide high quality image. However, this design is quite complicated.

Accordingly, the conventional display device must be improved to uniformly disperse the light and prevent the moire phenomenon under the conditions of simple manufacturing process, low cost and without increasing the thickness of the whole structure, thereby providing a preferred image quality.

### SUMMARY OF THE INVENTION

In view of the above problems, the main objective of the present invention is to provide a polarization structure and an LCD device having the same, thereby uniformly dispersing light and preventing the moire phenomenon.

Accordingly, in order to achieve the above objective, the polarization structure disclosed in the present invention comprises a polarizing film, a phase compensation film layer, and a diffusing adhesive layer. Here, the phase compensation film layer is disposed on the polarizing film, and the diffusing adhesive layer is disposed on one side of the phase compensation film layer opposite to the polarizing film. The diffusing adhesive layer has an adhesive material and a plurality of diffusing particles added into the adhesive material.

Furthermore, the diffusing adhesive layer can also be disposed between the phase compensation film layer and the polarizing film, so as to adhere the polarizing film to the phase compensation film layer. Otherwise, the diffusing adhesive layer is disposed on one side of the polarizing film opposite to the phase compensation film layer.

A LCD device having a backlight module, a lower polarization structure, an LCD panel, and an upper polarization structure is further provided. The lower polarization structure is disposed on the backlight module, the LCD panel is disposed on one side of the lower polarization structure opposite to the backlight module, and the upper polarization structure is disposed on one side of the LCD panel opposite to the lower polarization structure.

Herein, the lower polarization structure includes a diffusing adhesive layer having the adhesive material and a plurality of diffusing particles added into the adhesive material.

As such, by disposing the diffusing adhesive layer, the light can be dispersed uniformly and the moire phenomenon is avoided. Also, the manufacturing process is simple, the cost is low, and the thickness of the entire structure may not be increased.

The feature and practice of the present invention illustrated in detail below with reference to the drawings and preferred embodiments.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a backlight module according to the prior art;

FIG. 2 is a schematic view of another backlight module according to the prior art;

FIG. 3 is a schematic view of a polarization structure according to the first embodiment of the present invention;

FIG. 4 is a schematic view of a polarization structure according to the second embodiment of the present invention;

FIG. 5 is a schematic view of a polarization structure according to the third embodiment of the present invention;

FIG. 6 is a schematic view of a polarization structure according to the forth embodiment of the present invention;

FIG. 7 is a schematic view of a polarization structure according to the fifth embodiment of the present invention;

FIG. 8 is a schematic view of a polarization structure according to the sixth embodiment of the present invention;

FIG. 9 is a schematic view of a polarization structure according to the seventh embodiment of the present invention;

FIG. 10 is a schematic view of a polarization structure according to the eighth embodiment of the present invention;

FIG. 11 is a schematic view of a polarization structure according to the ninth embodiment of the present invention;

FIG. 12 is a schematic view of a polarization structure according to the tenth embodiment of the present invention;

FIG. 13 is a schematic view of a polarization structure according to the eleventh embodiment of the present invention;

FIG. 14 is a schematic view of a polarization structure according to the twelfth embodiment of the present invention;

FIG. 15 is a schematic view of a polarization structure according to the thirteenth embodiment of the present invention;

FIG. 16 is a schematic view of a polarization structure according to the fourteenth embodiment of the present invention;

FIG. 17 is a schematic view of an LCD device according to the present invention;

FIG. 18A shows the first embodiment of a lower polarization structure depicted in FIG. 17;

FIG. 18B shows the second embodiment of the lower polarization structure depicted in FIG. 17;

FIG. 18C shows the third embodiment of the lower polarization structure depicted in FIG. 17;

FIG. 18D shows the forth embodiment of the lower polarization structure depicted in FIG. 17;

FIG. 18E shows the fifth embodiment of the lower polarization structure depicted in FIG. 17;

FIG. 18F shows the sixth embodiment of the lower polarization structure depicted in FIG. 17;

FIG. 18G shows the seventh embodiment of the lower polarization structure depicted in FIG. 17;

FIG. 18H shows the eighth embodiment of the lower polarization structure depicted in FIG. 17;

FIG. 18I shows the ninth embodiment of the lower polarization structure depicted in FIG. 17;

FIG. 18J shows the tenth embodiment of the lower polarization structure depicted in FIG. 17;

FIG. 18K shows the eleventh embodiment of the lower polarization structure depicted in FIG. 17;

FIG. 18L shows the twelfth embodiment of the lower polarization structure depicted in FIG. 17;

FIG. 18M shows the thirteenth embodiment of the lower polarization structure depicted in FIG. 17;

FIG. 18N shows the fourteenth embodiment of the lower polarization structure in FIG. 17;

FIG. 19 shows the first embodiment of a backlight module depicted in FIG. 17;

FIG. 20 shows the second embodiment of the backlight module depicted in FIG. 17;

FIG. 21 shows the third embodiment of the backlight module depicted in FIG. 17;

FIG. 22 shows an embodiment of a LCD panel depicted in FIG. 17; and

FIG. 23 shows an embodiment of an upper polarization structure depicted in FIG. 17.

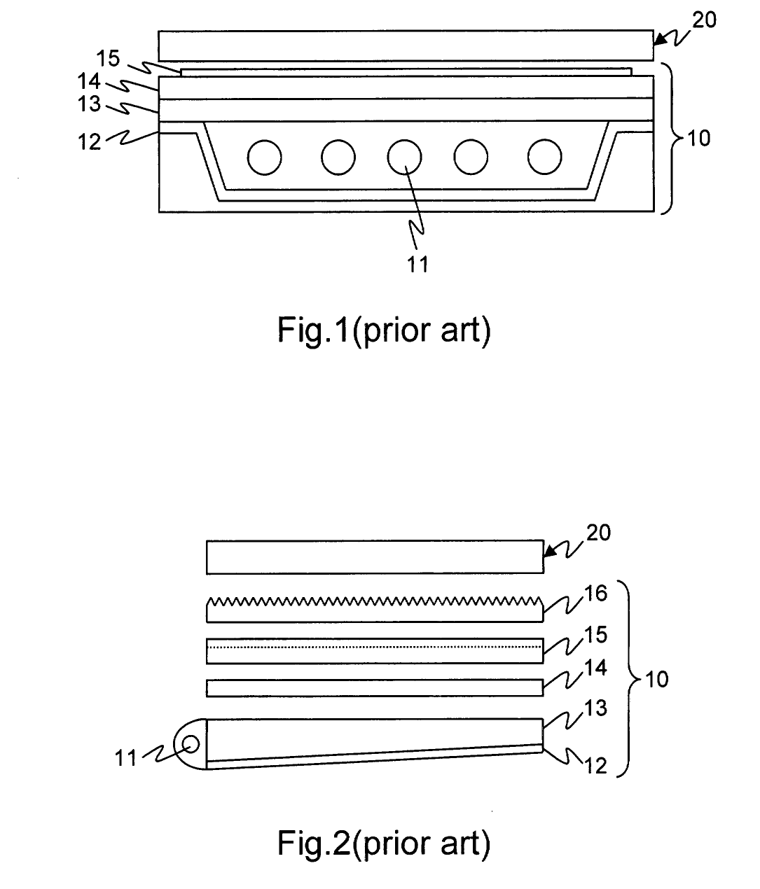

### DETAILED DESCRIPTION OF THE INVENTION

The content of the present invention is described in detail in the following detailed embodiments accompanied with the drawings. The symbols mentioned in the specification refer to those in the drawings.

The main concept of the present invention is first illustrated. The present invention mainly involves disposing a diffusing adhesive layer on the polarization structure of the LCD device, so as to uniformly disperse the light passing the diffusing adhesive layer and to prevent the moire phenomenon.

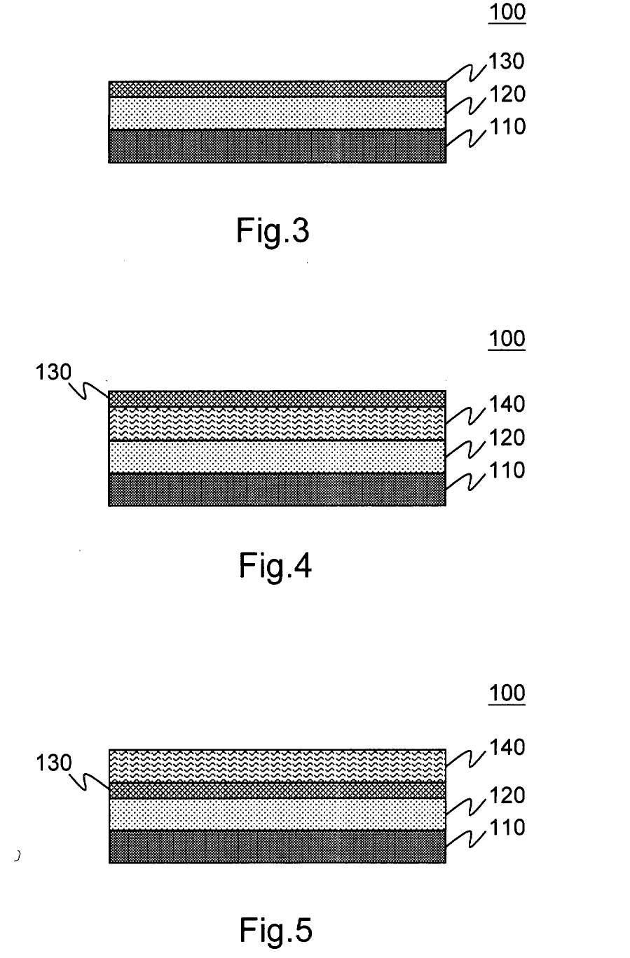

FIG. 3 shows a polarization structure according to the first embodiment of the present invention. The polarization structure includes a polarizing film 110, a phase compensation film layer 120, and a diffusing adhesive layer 130. Here, the phase compensation film layer 120 is disposed on the polarizing film 110, and the diffusing adhesive layer 130 is disposed on one side of the phase compensation film layer 120 opposite to the polarizing film 110. In other words, the phase compensation film layer 120 is disposed between the diffusing adhesive layer 130 and a polarizing film 110. The polarizing film 110 acts as a light filter for filtering the light not in the specific direction, and the polarizing film 110 is a film material having an optical characteristic of filtering the non-polarized light into the polarized light. The phase compensation film layer 120 includes at least a retarder plate for adjusting the chromatic polarization of the light emitted from the polarizing film 110. The diffusing adhesive layer 130 includes an adhesive material and a plurality of diffusing particles added into the adhesive material, thereby making the two components adjacent to the diffusing adhesive layer 130 being adhered together. Thus, by disposing the diffusing adhesive layer, the light can be dispersed uniformly, and the moire phenomenon is avoided. Meanwhile, the manufacturing process is simple, the cost is low, and the thickness of the entire structure may not be increased.

The rate of diffusion of the added diffusing particles is in a range of 7% to 80%, and preferably in a range of 40% to 80%. The thickness of the diffusing adhesive layer can be controlled between 10 μm and 50 μm, so as to effectively prevent the moire phenomenon without influencing the thickness of the entire structure.

Furthermore, a brightness enhancement film 140 is disposed on one side of the phase compensation film layer 120 opposite to the polarizing film 110, so as to enhance the brilliance of the light emitted from the phase compensation film layer 120 and to increase the degree of the viewing angle. That is, the brightness enhancement film 140 is disposed between the diffusing adhesive layer 130 and the phase compensation film layer 120, as shown in FIG. 4. Otherwise, the brightness enhancement film 140 is adhered to one side of the phase compensation film layer 120 opposite to the polarizing film 110 by the use of the diffusing adhesive layer 130, as shown in FIG. 5. The brightness enhancement film can be a cholesterol liquid crystal film, in which by using the basic characteristic of the material, the spiral incident light with the same pitch as the spiral liquid crystal is recovered and reused to achieve the efficacy of enhancing the brilliance exhibited by the polarization structure and meanwhile increasing the viewing angle.

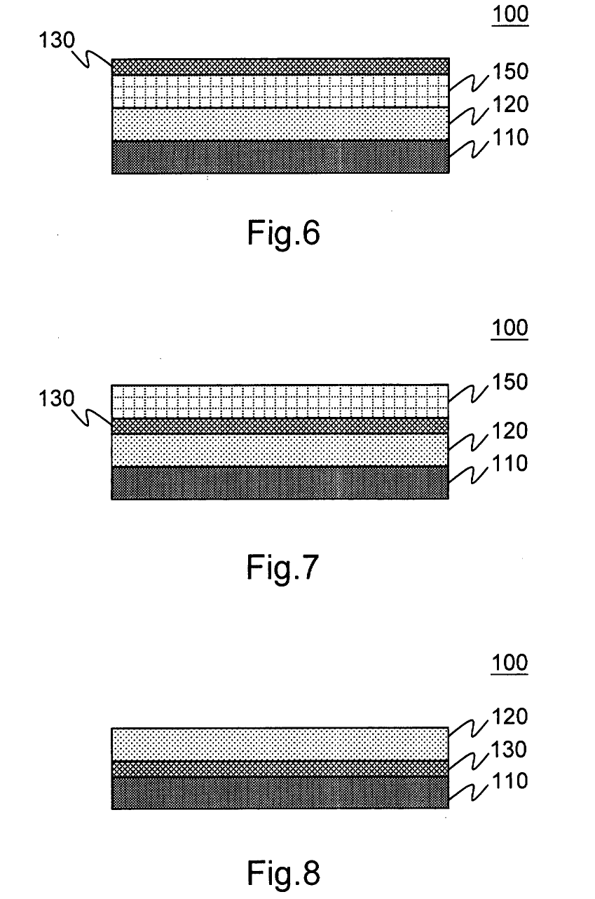

Moreover, an optical compensation film 150 is further disposed to eliminate the image stain or increase the viewing angle. That is, the optical compensation film 150 is disposed between the diffusing adhesive layer 130 and the phase compensation film layer 120, as shown in FIG. 6. Otherwise, the optical compensation film 150 is adhered to one side of the phase compensation film layer 120 opposite to the polarizing film 110 by the use of the diffusing adhesive layer 130, as shown in FIG. 7.

Referring to FIG. 8, the diffusing adhesive layer 130 can also be disposed between the polarizing film 110 and the phase compensation film layer 120, thereby making the polarizing film 110 being adhered to the phase compensation film layer 120.

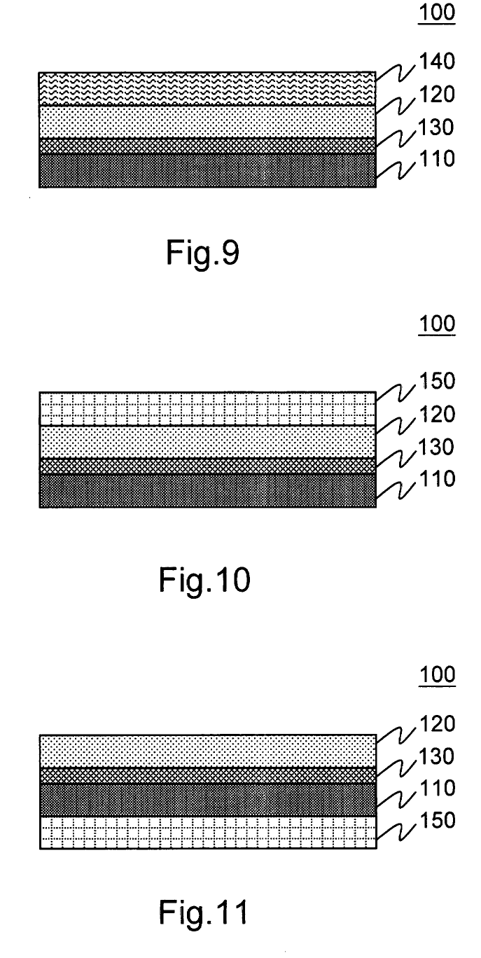

Likewise, a brightness enhancement film 140 can also be disposed on one side of the phase compensation film layer 120 opposite to the diffusing adhesive layer 130, as shown in FIG. 9.

Moreover, an optical compensation film 150 can also be disposed on one side of the phase compensation film layer 120 opposite to the diffusing adhesive layer 130, as shown in FIG. 10. Otherwise, an optical compensation film 150 is disposed on one side of the polarizing film 110 opposite to the diffusing adhesive layer 130, as shown in FIG. 11.

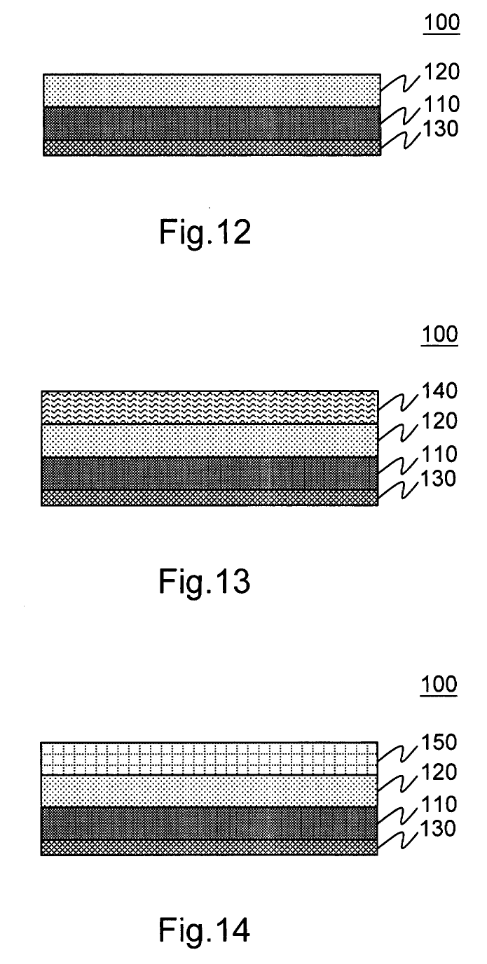

Referring to FIG. 12, the diffusing adhesive layer 130 can also be disposed on one side of the polarizing film 110 opposite to the phase compensation film layer 120.

Moreover, a brightness enhancement film 140 can also be disposed on one side of the phase compensation film layer 120 opposite to the diffusing adhesive layer 130, as shown in FIG. 13.

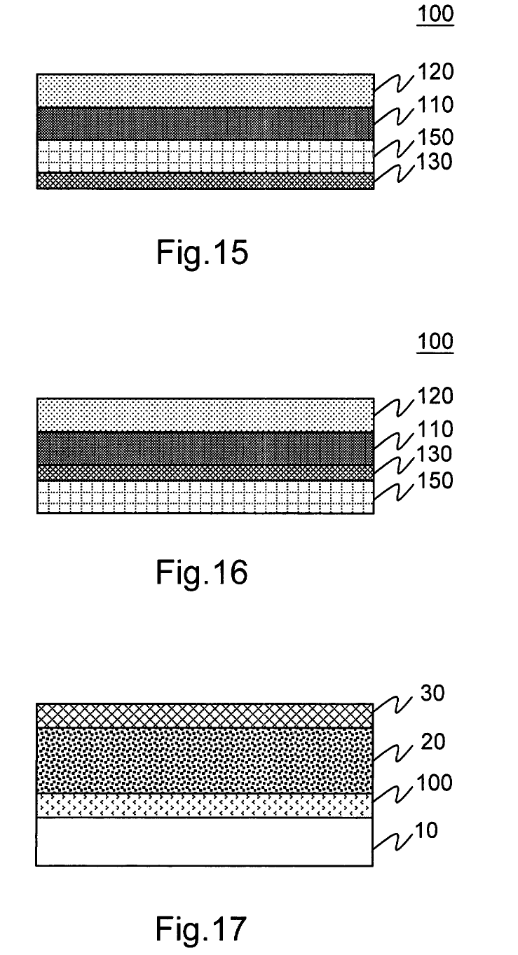

Likewise, an optical compensation film 150 can be disposed on one side of the phase compensation film layer 120 opposite to the polarizing film 110, as shown in FIG. 14. Otherwise, an optical compensation film 150 is disposed between the polarizing film 110 and the diffusing adhesive layer 130, as shown in FIG. 15. Or, an optical compensation film 150 is adhered to one side of the polarizing film 110 opposite to the phase compensation film layer 120 by the use of the diffusing adhesive layer 130, as shown in FIG. 16.

Referring to FIG. 17, it is a schematic view of an LCD device according to the present invention. The LCD device includes a backlight module 10, a lower polarization structure 100, an LCD panel 20, and an upper polarization structure 30, which are successively stacked. That is, the lower polarization structure 100 is disposed on the backlight module 10, the LCD panel 20 is disposed on one side of the polarization structure 100 opposite to the backlight module 10, and the upper polarization structure 30 is disposed on one side of the LCD panel 20 opposite to the lower polarization structure 100.

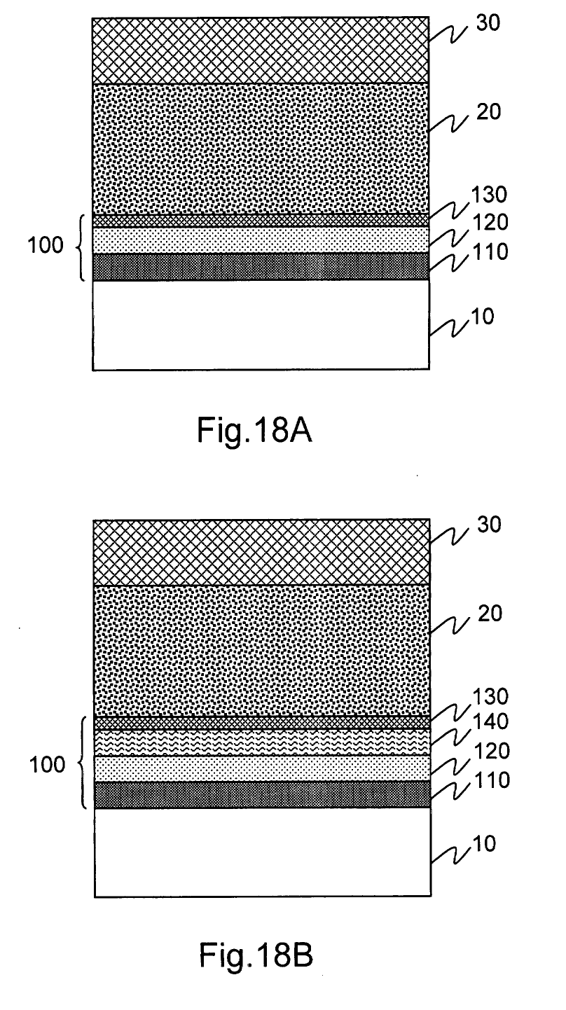

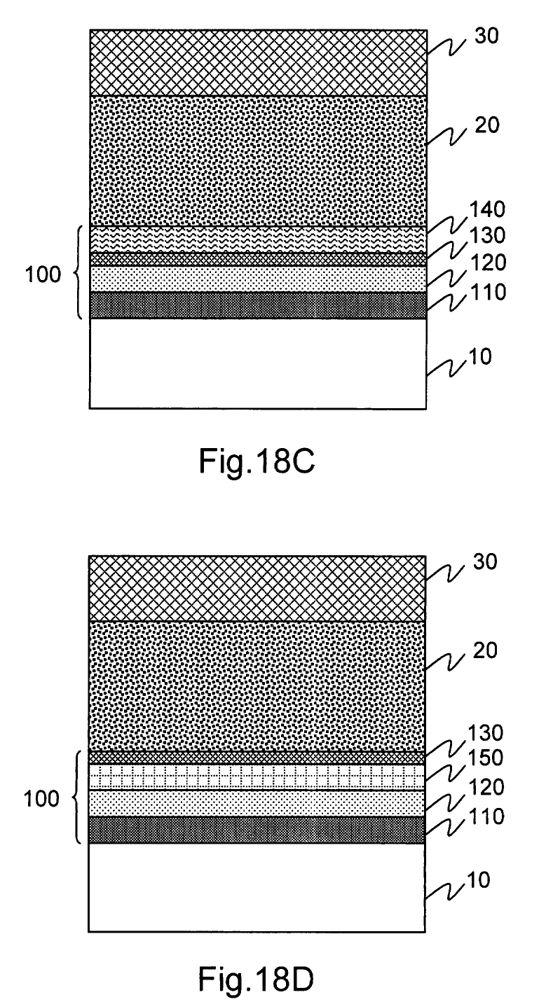

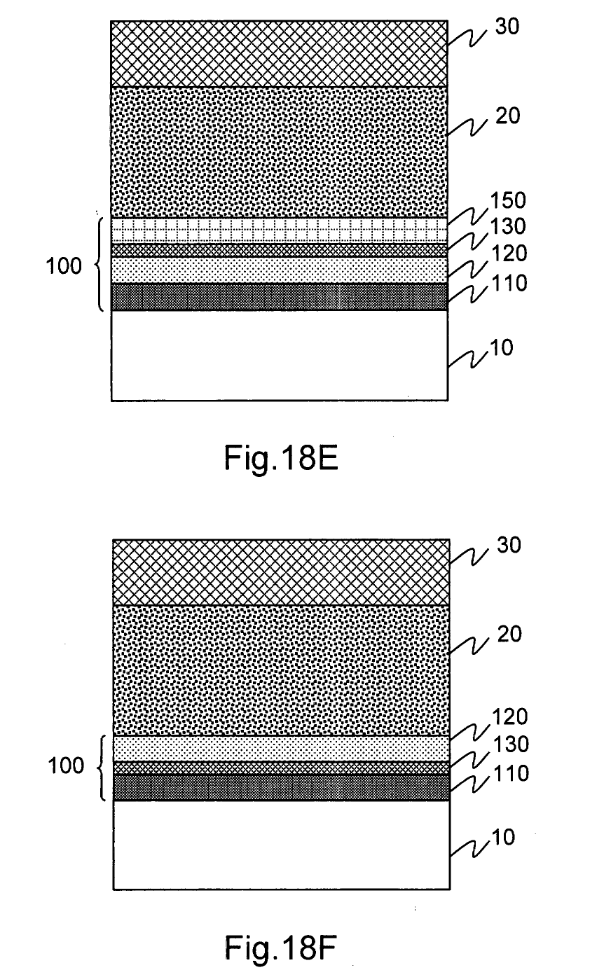

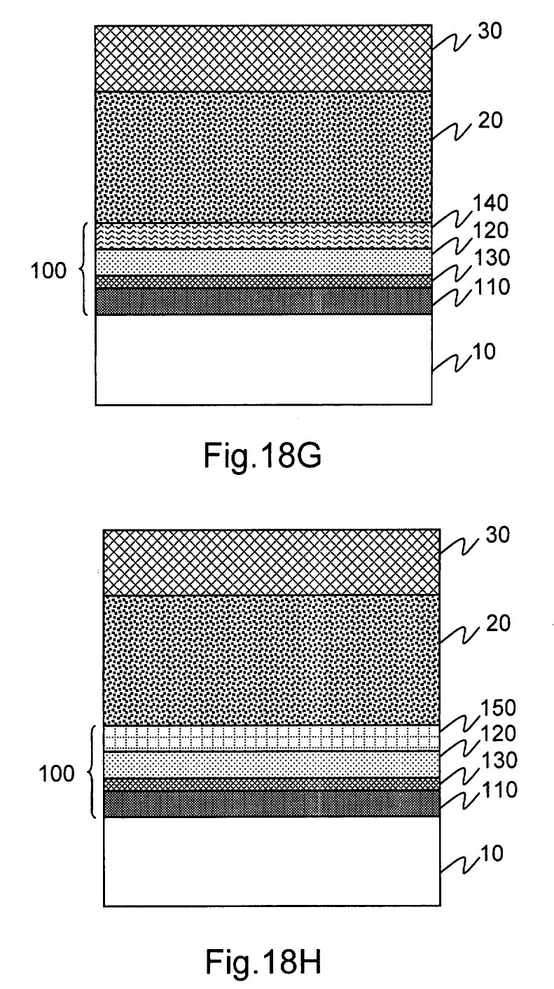

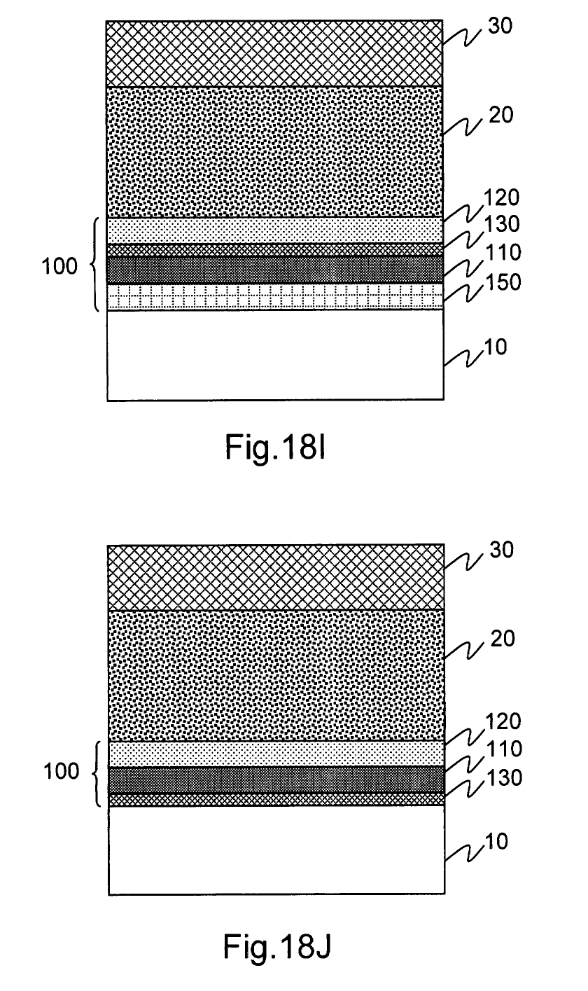

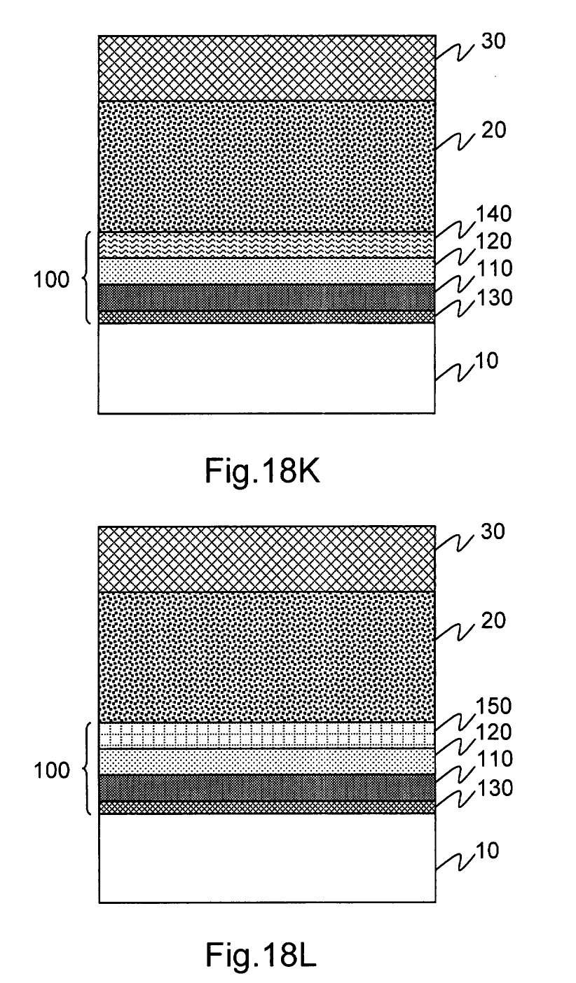

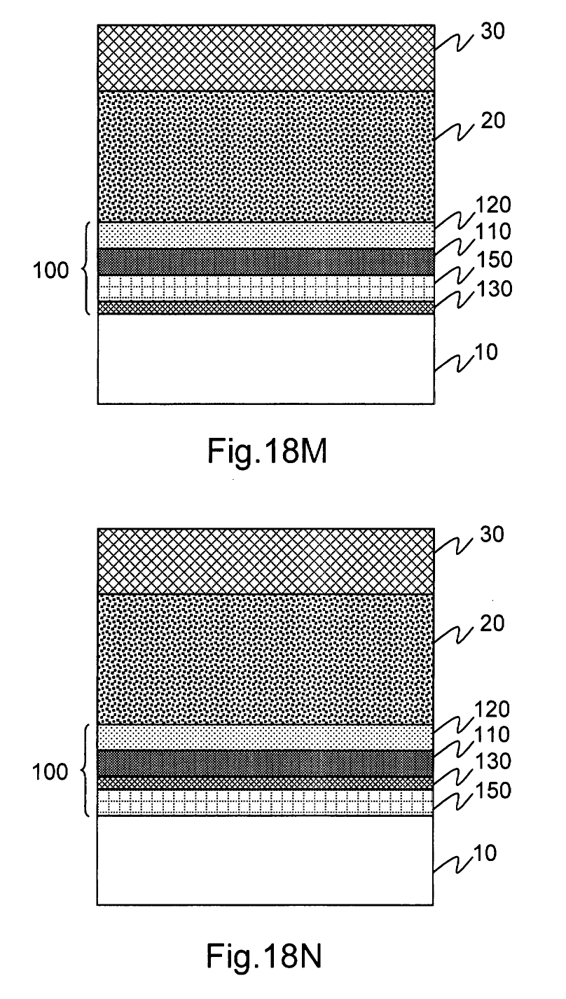

Herein, the lower polarization structure 100 can adopt a polarization structure in any one of the above embodiments. That is, the lower polarization structure 100 includes a diffusing adhesive layer 130 in which a plurality of diffusing particles is added to uniformly disperse the light and prevent the moire phenomenon. Meanwhile, the manufacturing process is simple, the cost is low, and the thickness of the entire structure may not be increased, as shown in FIGS. 18A to 18N.

The diffusing adhesive layer 130 includes an adhesive material and a plurality of diffusing particles added into the adhesive material, thereby making the two elements adjacent to the diffusing adhesive layer 130 being adhered together. And, the rate of diffusion of the added diffusing particles is in a range of 7% to 80%, and preferably in a range of 40% to 80%. The thickness of the diffusing adhesive layer can be controlled between 10 μm and 50 μm, so as to effectively prevent the moire phenomenon without influencing the thickness of the whole structure.

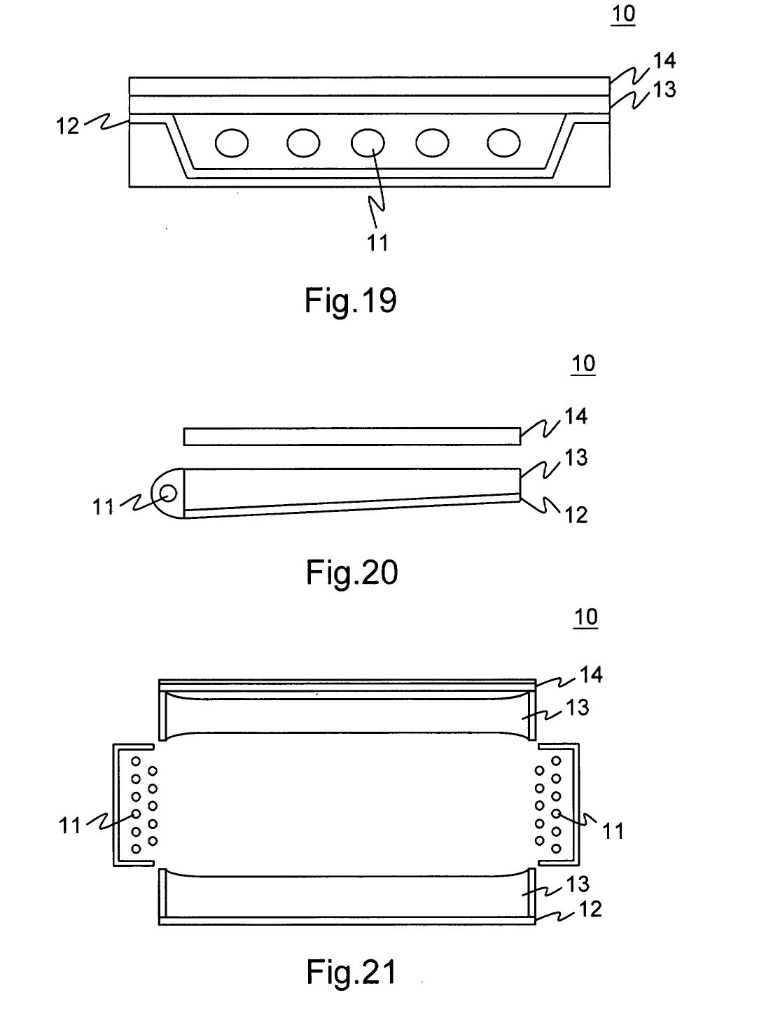

Herein, the backlight module 10 can be a direct type structure (as shown in FIG. 19), a side type structure (as shown in FIG. 20), or a hollow type structure (as shown in FIG. 21), and includes a light source generator 11, a reflecting plate 12, a light guide plate 13, and a diffusion sheet 14. Herein, the light generated by the light source generator 11 is diffused into the lower polarization structure (not shown) by the diffusion sheet 14, thereby providing uniformly dispersed light to the LCD panel. The light source generator generally includes the types such as an LED (light emitting diode), an EL (Electro-Luminescence), and a CCFL (cold cathode fluorescent lamp). One or more prism sheets are further disposed between the diffusion sheet and the lower polarization structure, so as to further rectify the difference of the light intensity. The details of the structure, progress, and material of various backlight modules are well known to those skilled in the art, and will not be described herein again.

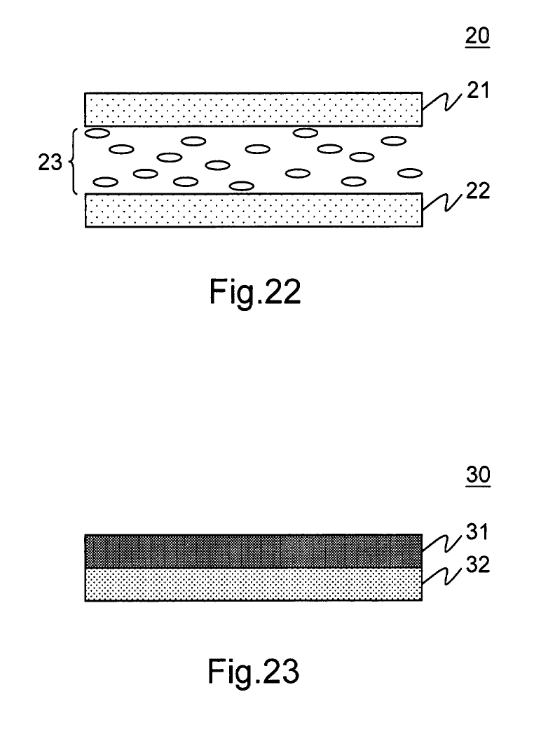

Referring to FIG. 22, the LCD panel 20 mainly includes a first substrate 21, a second substrate 22, and a liquid crystal layer 23 formed between the first substrate 21 and the second substrate 22. Herein, the first substrate 21 is near the upper polarization structure (not shown), and the second substrate 22 is near the lower polarization structure (not shown). Furthermore, when the LCD device is a color LCD device, the first substrate is a color filter substrate (CF substrate). The details of the structure, progress, and material of various LCD panels are well known to those skilled in the art, and will not be described herein again.

Referring to FIG. 23, the upper polarization structure 30 can be a conventional polarization structure, which includes a phase compensation film layer 32 and a polarizing film 31, which are successively stacked. That is, the phase compensation film layer 32 is disposed on one side of the LCD panel 20 opposite to the lower polarization structure 100, and the polarizing film 31 is disposed on one side of the phase compensation film layer 32 opposite to the LCD panel 20. The details of the structure, progress, and material of the upper polarization structure are well known to those skilled in the art, and will not be described herein again.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A polarization structure, comprising:
a polarizing film;
a phase compensation film layer disposed on one side of the polarizing film; and
a diffusing adhesive layer disposed on one side of the phase compensation film layer opposite to the polarizing plate and having a plurality of diffusing particles.

2. The polarization structure as claimed in claim 1, wherein the rate of diffusion of the diffusing particles is in a range of 40% to 80%.

3. The polarization structure as claimed in claim 1, wherein the diffusing adhesive layer further comprises an adhesive material in which the diffusing particles are added.

4. The polarization structure as claimed in claim 1, further comprising a brightness enhancement film disposed on one side of the diffusing adhesive layer opposite to the phase compensation film layer, or disposed between the diffusing adhesive layer and the phase compensation film layer.

5. The polarization structure as claimed in claim 1, further comprising an optical compensation film disposed on one side of the diffusing adhesive layer opposite to the phase compensation film layer, or disposed between the diffusing adhesive layer and the phase compensation film layer, or disposed on one side of the polarizing film opposite to the phase compensation film layer.

6. A polarization structure, comprising:
a polarizing film;
a diffusing adhesive layer having a plurality of diffusing particles; and
a phase compensation film layer adhered to the polarizing film by the use of the diffusing adhesive layer.

7. The polarization structure as claimed in claim 6, wherein the rate of diffusion of the diffusing particles is in a range of 40% to 80%.

8. The polarization structure as claimed in claim 6, wherein the diffusing adhesive layer further comprises an adhesive material in which the diffusing particles are added.

9. The polarization structure as claimed in claim 6, further comprising a brightness enhancement film disposed on one side of the phase compensation film layer opposite to the diffusing adhesive layer.

10. The polarization structure as claimed in claim 6, further comprising an optical compensation film disposed on one side of the phase compensation film layer opposite to the diffusing adhesive layer, or disposed on one side of the polarizing film opposite to the diffusing adhesive layer.

11. A polarization structure, comprising:
a polarizing film;
a phase compensation film layer disposed on one side of the polarizing film; and
a diffusing adhesive layer disposed on one side of the polarizing plate opposite to the phase compensation film layer and having a plurality of diffusing particles.

12. The polarization structure as claimed in claim 11, wherein the rate of diffusion of the diffusing particles is in a range of 40% to 80%.

13. The polarization structure as claimed in claim 11, wherein the diffusing adhesive layer further comprises an adhesive material in which the diffusing particles are added.

14. The polarization structure as claimed in claim 11, further comprising a brightness enhancement film disposed on one side of the phase compensation film layer opposite to the polarizing film.

15. The polarization structure as claimed in claim 11, further comprising an optical compensation film disposed on one side of the phase compensation film layer opposite to the polarizing film, or disposed between the diffusing adhesive layer and the polarizing film, or disposed on one side of the diffusing adhesive layer opposite to the polarizing film.

16. A liquid crystal display (LCD) device, comprising:
a backlight module;
a lower polarization structure disposed on one side of the backlight module and having a diffusing adhesive layer in which a plurality of diffusing particles is added;
an LCD panel disposed on one side of the lower polarization structure opposite to the backlight module; and
an upper polarization structure disposed on one side of the LCD panel opposite to the lower polarization structure.

17. The LCD device as claimed in claim 16, wherein the rate of diffusion of the diffusing particles is in a range of 40% to 80%.

18. The LCD device as claimed in claim 16, wherein the lower polarization structure further comprises:
a diffusing adhesive layer disposed on one side of the LCD panel opposite to the upper polarization structure and having an adhesive material in which the diffusing particles are added;
a phase compensation film layer disposed on one side of the diffusing adhesive layer opposite to the LCD panel; and
a polarizing film disposed on one side of the phase compensation film layer opposite to the LCD panel.

19. The LCD device as claimed in claim 18, wherein the lower polarization structure further comprises a brightness enhancement film disposed on one side of the diffusing adhesive layer opposite to the phase compensation film layer, or disposed between the diffusing adhesive layer and the phase compensation film layer.

20. The LCD device as claimed in claim 18, wherein the lower polarization structure further comprises an optical compensation film disposed on one side of the diffusing adhesive layer opposite to the phase compensation film layer, or disposed between the diffusing adhesive layer and the phase compensation film layer, or disposed on one side of the polarizing film opposite to the phase compensation film layer.

21. The LCD device as claimed in claim 16, wherein the lower polarization structure further comprises:
a phase compensation film layer disposed on one side of the LCD panel opposite to the upper polarization structure; and
a polarizing film disposed on one side of the phase compensation film layer opposite to the LCD panel and being adhered to the phase compensation film layer by use of the diffusing adhesive layer;
wherein the diffusing adhesive layer has an adhesive material in which the diffusing particles are added.

22. The LCD device as claimed in claim 21, wherein the lower polarization structure further comprises a brightness enhancement film disposed on one side of the phase compensation film layer opposite to the diffusing adhesive layer.

23. The LCD device as claimed in claim 21, wherein the lower polarization structure further comprises an optical compensation film disposed on one side of the phase compensation film layer opposite to the diffusing adhesive layer, or disposed on one side of the polarizing film opposite to the diffusing adhesive layer.

24. The LCD device as claimed in claim 16, wherein the lower polarization structure further comprises:
a phase compensation film layer disposed on one side of the LCD panel opposite to the upper polarization structure; and
a polarizing film disposed on one side of the phase compensation film layer opposite to the LCD panel; and
a diffusing adhesive layer disposed on one side of the polarizing film opposite to the phase compensation film layer and having an adhesive material in which the diffusing particles are added.

25. The LCD device as claimed in claim 24, wherein the lower polarization structure further comprises a brightness enhancement film disposed on one side of the phase compensation film layer opposite to the polarizing film.

26. The LCD device as claimed in claim 24, wherein the lower polarization structure further comprises an optical compensation film disposed on one side of the phase compensation film layer opposite to the polarizing film, or disposed between the diffusing adhesive layer and the polarizing film, or disposed on one side of the diffusing adhesive layer opposite to the polarizing film.
